(19) United States
(12) Patent Application Publication
(10) Pub. No.: US 2006/0053216 A1
(43) Pub. Date: Mar. 9, 2006

(54) Clustered computer system with centralized administration

(75) Inventors: Vipul B. Deokar, Fremont, CA (US); Rohit Sharma, Palo Alto, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: MetaMachinix, Inc., Menlo Park, CA (US)

(21) Appl. No.: 11/083,712

(22) Filed: Mar. 18, 2005

Related U.S. Application Data
(63) Continuation-in-part of application No. 10/935,256, filed on Sep. 7, 2004.

(51) Int. Cl. G06F 15/173

(52) U.S. Cl. 709/223

(57) ABSTRACT

Systems and methods for a computer cluster and for conducting user sessions in a managed enterprise computer network. A cluster includes multiple inter-connected nodes with specific roles. Master nodes administer and monitor slave nodes and the slave nodes are used to conduct user sessions with users through terminal nodes that provide an interface to the cluster. The cluster also may include server nodes that provide network services. Master nodes also control admittance to the cluster of external nodes and sub-clusters. Admin nodes form a control plane used to control and administer the cluster through the master nodes. The cluster provides a virtual environment for the user session that is built from at least an operating system image, an application image and other data needed for the user session.

### CROSS-REFERENCE TO RELATED APPLICATIONS

This application is a continuation-in-part of U.S. application Ser. No. 10/935,256, filed Sep. 7, 2004, which is hereby incorporated by reference in its entirety.

### BACKGROUND OF THE INVENTION

1. The Field of the Invention

Embodiments of the present invention relate to the field of computers and computer networks. More particularly, embodiments of the present invention relate to computer clusters and to systems and methods for providing multiple users with secure access to computing resources in an enterprise computer cluster including of a variety of computing devices with centralized administration.

2. Background and Relevant Art

The advance of computer networks has led to a corresponding increase in the requirements and complexity of computer programs. As technological advances such as faster processing power and memory capacity occur, computer programs have taken advantage of these advances to provide the user with a better experience and more powerful computation. Computing tasks performed by typical desktop users rarely use the full processing power of each computer. As a result, the processing power of most desktop computers is underutilized. Since each person in an enterprise typically has a relatively powerful desktop computer, much of the processing power is unused. Moreover, since each desktop computer can be configured to provide the required set of computer programs to the user that may be unique, several complex computer configurations may exist at any given time within an enterprise. When faults occur, information technology workers face a complicated set of issues arising from the interaction of these multiple configurations with complex programs and hardware configurations. As a result, enterprises are incurring significant costs for processing power that is underutilized as well as additional costs for administration of a large number of unique desktop computer configurations.

There are many processing tasks that require significant processing power and that may not be adequately serviced by a conventional desktop computer or even by a server computer. One of the ways that the processing requirements of these tasks are satisfied is through the use of computer clusters. Conventionally, clusters are typically an interconnected group of machines that are dedicated to a specific computational goal. A cluster, for example, may be configured to handle computer programs that are written for parallel execution. In other words, each processor or unit of the cluster can execute the various requirements of the computer program at the same time to decrease the required processing time.

Other clusters are arranged to perform load balancing. Internet portals, for example, may use a form of load balancing. Requests for data are directed to servers that are best able to service the incoming requests. By spreading the requests across the cluster, the request can be serviced in a timely manner. A cluster clearly makes sense in these types of tasks where the need for processing power is significant and provides a low cost solution.

In some networks, however, the use of a specialized cluster to perform load balancing may be an unjustifiable expense. Further, typical programs may not be written to take advantage of clusters that operate with parallelism. In order to take advantage of the capabilities of some clusters, the programs would have to be rewritten.

At the same time, many enterprises are burdened with desktop systems that have significant processing capabilities that are only available to a single user. Also, many of the individual desktop systems have different programs as well as different operating systems and even different hardware or peripheral devices, a fact that introduces complexity into the management of the different systems in a computer network by introducing individual and unique configurations on each user's desktop computer system.

Systems and methods are needed that can reduce the cost of computer networks, centrally install, upgrade, administer and control various operating systems, software programs, applications, and simplify administration and maintenance of shared computer resources, while still providing users with the computing resources required by the end-users.

### BRIEF SUMMARY OF THE INVENTION

These and other limitations are overcome by embodiments of the present invention, which relate to systems and methods for providing a cluster computer system with centralized administration. In a cluster, according to embodiments of the invention, each cluster member or node includes one or more computer machines having at least a processor, memory, and a network interface. In a singular or distributed enterprise environment, operating diverse desktop computers, servers, and other shared network resources as a centrally provisioned and administered cluster can overcome the limitations stated previously.

The nodes of the cluster can be adapted and directed to perform various roles, to provide a well-defined management hierarchy and division of labor. A master node administrates admission of nodes into the cluster, and provisions a set of slave nodes. The master nodes provision the cluster with software images, distribute and control user sessions across slave nodes, monitor the slave node hardware and software, and provide access to shared resources (file systems, printers, etc.) over one or more networks. The slave nodes report to the master node and are used to conduct user sessions in some instances. Some slave nodes can also perform the role of master for other slave nodes. Server nodes provide various services during user sessions as well as to all members of the cluster as needed. A node within the cluster may undertake multiple roles. The nodes within a cluster are interconnected via a local area computer network or a wide area computer network.

Requests to join the cluster from an external node are directed to a master node. The master node then authenticates the requesting node and adds the node to the cluster if authenticated under the appropriate policies. After admission to the cluster, a role is assigned to the newly admitted node and the node is brought to an appropriate state. Another cluster may be added to the main cluster as a sub-cluster. A sub-cluster can include multiple nodes. When a sub-cluster is admitted to a cluster, each of the nodes in the sub-cluster can continue in their assigned role. Alternatively, the nodes can be assigned new roles once admitted to the cluster.

User sessions are initiated by a user at a terminal node by sending a request to the designated master node within the cluster. The terminal nodes, in addition to a processor, memory and network interface, provide a keyboard, mouse and video/graphical display as input/output resources to the user. The master node receiving the request for the user session authenticates the user and the terminal node. If approved, the user session is assigned to a slave node and resources are allocated to the slave node. The slave node loads the appropriate firmware, operating system image, application image, etc., and conducts the user session with the terminal node user. The user session can be backed up if desired at one or more nodes within the same cluster or another cluster.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of a cluster implemented in an exemplary environment including a computer network;

FIG. 2 illustrates examples of properties that are associated with a node depending on a role of the node;

FIG. 3 illustrates a logical view of one embodiment of a cluster and illustrates the division between software and hardware in the cluster;

FIG. 4 illustrates one example of the states of nodes in a cluster;

FIG. 5 illustrates an example of the requests that are received by nodes in a cluster;

FIG. 6 illustrates one embodiment of a method for admitting a node to a cluster;

FIG. 7 illustrates one embodiment of a method for admitting a sub-cluster to a main cluster;

FIG. 8 illustrates one embodiment of a method for initiating a user session on a cluster from a terminal node;

FIG. 9 illustrates en exemplary embodiment of a cluster adapted for use in an enterprise; and

FIG. 10 illustrates an exemplary embodiment of an enterprise cluster over different locations.

### DETAILED DESCRIPTION OF THE PREFERRED EMBODIMENTS

Embodiments of the present invention relate to a cluster with diverse computers and centralized administration. A cluster, in accordance with the present invention, provides an infrastructure with centralized manageability. The centralized manageability of the cluster typically includes a control plane or an interface to an enterprise control plane that provides a channel to monitor and govern cluster functions including, by way of example, operation, administration, management, and provisioning.

Introduction to Cluster Organization and Cluster Operation

Typically, embodiments of a cluster include various nodes that are organized in a master-slave arrangement. While each node has processing power, each node can be a master node, a slave node, a master and a slave node, as well as others described in more detail herein. Each master node is typically associated with multiple slave nodes. As a result, master node(s) enables an administrator to administrate a cluster as a monolithic system, while having access to the resource information of each node in the cluster.

Administering and provisioning a cluster entails, by way of example and not limitation, maintaining and distributing system software images, distributing submitted user sessions across slave nodes of the cluster, monitoring the slave nodes and state of the cluster, and providing access to shared resources. The master nodes also control admission into the cluster and provide monitoring information regarding members of the cluster to an administrator. The master nodes also effect any policy or software image changes in the cluster, while maintaining continued operation and service to users.

When a node is provisioned with, for example, system software images, it may be performed by a node other than the master node. The master node, however, should be aware of the information available on the various nodes of the cluster or at least on its slave nodes. Typically, a small controlled set of system software images is shared between nodes of a cluster, and between users of the cluster. This helps avoid situations where different members of a cluster have different versions of software, which could further lead to diverging software install base across the enterprise. A controlled set of images also facilitates software maintenance and update, and improves the ability to recover the cluster from a failure or other disaster. The software images themselves may be stored on network-attached storage devices, and may be served by server nodes external to the cluster.

End users are often interested in running their applications, often on a particular operating system. A cluster can provide a virtualization environment that enables multiple operating system types and instances to be running within their own virtual containers, on a single physical machine/node. Each such virtual container isolates the functional environment for each operating system instance as if only that operating system was executing on the computer. A cluster can thus provide a user session to an end user as a virtual container that includes a particular application or set of applications on a particular operating system. The user experience during the user session is then very close if not same as if working on a desktop computer.

A virtual container is an example of a controlled or managed virtual machine. When using a virtual container for a user session, the user session can be controlled, provisioned and configured. The virtual containers can ensure that user sessions have consistent environments as the user sessions are executed. A virtual container provides an administrator with control over the use of resources allocated to the user session. In addition, the virtual container can be used to control, by way of example, security settings, network setting, copy permissions of enterprise data to locally attached devices on terminal nodes, and the like. A virtual container can be configured with policies determined to be applicable to the user allocated to that container. A virtual container can be used to control which resources (both local and remote) can be accessed.

One advantage of the cluster is that if the physical slave node that the user is attached to fails, then the disruption to the user can be minimal as the user session migrates to another slave node within the cluster. This can be achieved by backing up the user session as it occurs, for example.

Exemplary Cluster Environment

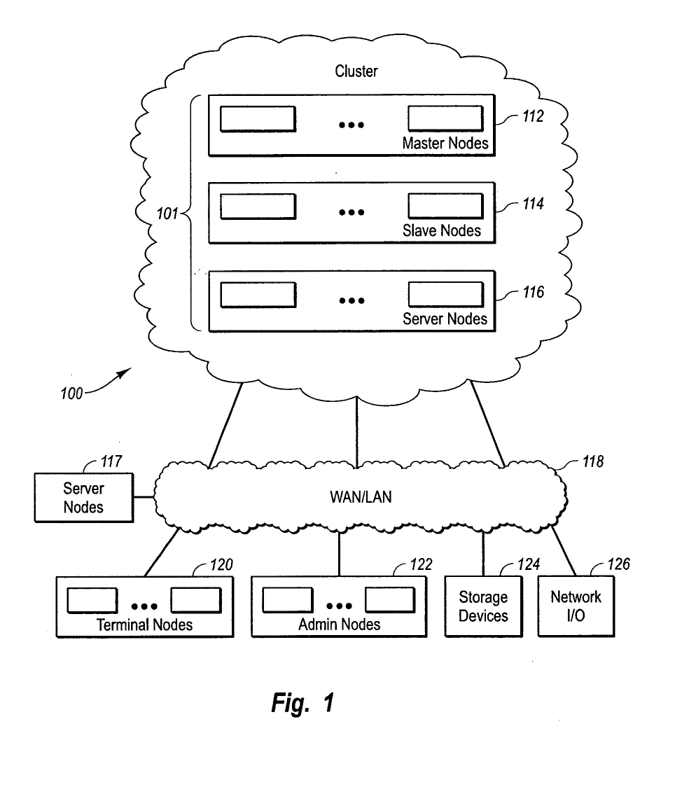

FIG. 1 illustrates an exemplary embodiment of the invention including a cluster. The cluster 1 10, in a general sense, is a collection of hardware and software that provides computing resources to users. The cluster 110 can be implemented as a collection of nodes that can be allocated to have different functions and relationships with respect to other nodes within the cluster. One exemplary function of the cluster 110 is to provide, manage and allocate computing resources.

The cluster 110 includes the nodes 101 that can be configured and reconfigured in various roles. Generally, a node includes at least one processor, memory, and a network interface. Depending on the role of the node, the node may also have additional resources such as a disk, keyboard, mouse, video I/O, and the like as well as related software. The nodes can be embodied as commodity hardware such as blades, desktop computers, laptop computers, mobile devices, and the like or any combination thereof.

A cluster 110 can include multiple nodes that have different roles within the cluster 110. Nodes can gain admittance to the cluster as well as leave the cluster. Although FIG. 1 illustrates the storage devices 124, and the network I/O 126 as being outside of the cluster 110, these same resources can also be included within the cluster 110 in another example. Although FIG. 1 illustrates the terminal nodes 120 and the admin nodes 122 as being an interface to the cluster 110, these same nodes can also be performing a secondary function as part of the cluster 110 in another example. The resources of a terminal node, for example, may be allocated to a user session initiated at another terminal computer. This may occur, for example, when the terminal nodes are desktop computers. The nodes are interconnected over network connections such as the network 118.

Terminal nodes 120 typically provide the end-users with an interface to the cluster 110 through the network 118. Because the terminal nodes 120 are used to interface with the cluster 110, each terminal node 120 typically includes a keyboard, video monitor, mouse I/O, and the like that enable the end-user to utilize the computing resources of the cluster 110. The terminal nodes can be embodied as thin client devices and also as other computer devices mentioned herein.

The admin nodes 122 are nodes that have administrative control over the network 100 including the cluster 110. The admin nodes 122 may be a part of the cluster 110 and are included in a control plane used to access and manage the cluster 110. The admin nodes 122 typically administer admission to the cluster, server provisioning, fail-over procedures, implement policies, and the like. The admin nodes 122 interact with the master nodes 112 to determine the state of the cluster 110, although the admin nodes 122 can also access the slave nodes 114.

The master nodes 112 are nodes that have a master role within the cluster 110 and the slave nodes 114 are nodes that have a slave role within the cluster 110. Slave nodes 116 are the nodes that are administered by the master nodes 114. Typically, each master node may handle the administration for a sub-set of the slave nodes 116. A master node may also administer the server nodes 116 or a sub-set of the server nodes 116. In some instances, a master node may be a slave node to another master node.

The server nodes 116 are nodes within the network 100 that provide various services including, but not limited to, user-authentication, file/print sharing, Internet access, electronic messaging services, naming functionality, and the like or any combination thereof. The server nodes 116 may be configured to provide specific function to other nodes in the cluster 110. A server node 116, for example, may serve system image files to newly admitted nodes, serve network files, provide a firewall/gateway to an external network, and the like. Master nodes 112 are typically provided with data regarding the server nodes 116. As illustrated in FIG. 1, some of the server nodes 117 may be outside of the cluster 110. In other words, server nodes of a cluster can be integrated with the cluster 110 (server nodes 116) and/or external to the cluster 110, as illustrated by the server nodes 117.

The storage devices 124 and the network I/O 126 can be either controlled by nodes within the cluster 110 or be external to the cluster 110. The storage devices 124, such as SAN/NAS may be controlled by the server nodes 116. Similarly, network I/O such as printers may also be controlled by the server nodes 116.

The organization or relationships between master nodes and slave nodes can take various forms. For example, the node assigned as a master node to slave nodes when the slave nodes are first added to the cluster is referred to as a primary master. The primary master may be backed up by a secondary master, which is a master node that manages the slave nodes if the primary master fails. This provides some of the redundancy that ensures that the computing resources of a cluster will be made available to end-users in the case of failure or other disaster, and that the cluster will remain manage-able.

A rooted cluster is a cluster where all of the nodes are slave nodes, directly or indirectly, to a particular master node. The hierarchical arrangement of nodes of a cluster is complete and the master node that is not a slave to any other node is typically called the root of the cluster.

The computing resources of the cluster 110 are allocated to users during user sessions. A user session is an executable that provides a desktop experience to a user at a terminal node. In other words, the nodes 101 cooperate to allocate computing resources to a user. The computing resources allocated during a user session typically include, an operating system image, an application image, user data, and the like. The user session may be conducted in a virtual mode. However, the user experience may be akin to using a conventional desktop computer or wireless device, etc.

More particularly, the request for a user session is typically received by a master node that assigns the user session to a slave node after appropriate authentication. The user session is established with the slave node and the user has access to the allocated resources including operating system, application, and other network resources as required.

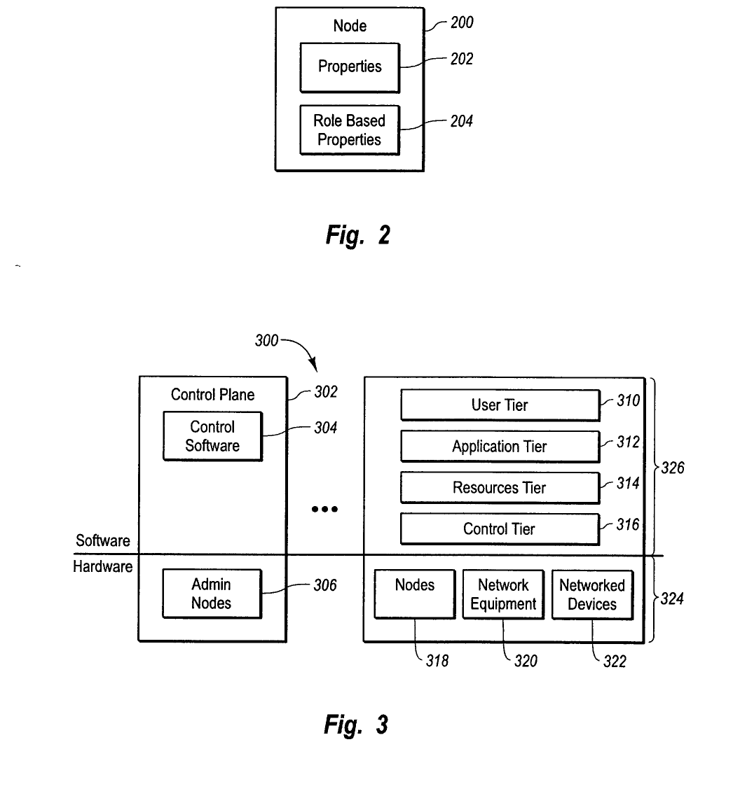

FIG. 2 illustrates that each node 200 has properties 202. Each node may also have role based properties 204. In this case, the properties 202 represent an example of the properties that are common to all nodes without regard for the specific role of the node 200. The properties 202 may include, but are not limited to:
role property property (e.g., master, slave, server, admin) that identifies a role of the node 200;
state identifies the particular state of the node 200;
identifier unique identifier for the node within the cluster;
primary master ID of the node's master;
backup master(s) ID of the node's secondary master(s);
Heartbeat policy Nature of heartbeats exchanged with master;
Policy on Master Failure Defines actions to perform when primary and/or secondary masters fail;
Resource usage profile on use of computing resources;
Software, Boot Protocol, Servers Information on boot software to run, protocol and server locations; and
Policy on communication Specifies how communication with other nodes or external nodes occurs (e.g., encrypted, unencrypted, compressed/uncompressed, etc.).

The node 200 may include other role based properties 204, in addition to the properties 202, based on the role of the node 200. The properties 204 may include, but are not limited to the following:

For a node with a master role:
List of slaves
Configuration data for each slave May include the slave's properties;
Monitoring data for each slave May include resource usage view, active user session information, etc;
Policy on interaction with an admin node; and
Policy on user session scheduling for slave nodes.

For a node with a slave only role (node is not also a master):
monitoring information May include user session information, master state information, etc.

For a node with a server role:
authentication policy May include rules to accept/reject client request;
Monitoring information May include client transaction history, master state information, etc.

FIG. 3 illustrates a logical view of a cluster 300, which is an example of the cluster 110 illustrated in FIG. 1. The logical view 300 illustrates a control plane 302 that includes software 304 and hardware 306. The control plane 302 includes the admin nodes as well as the software running on the admin nodes. To the extent that the software 302 executes on other nodes or components of the cluster 300, those nodes and components become part of the control plane 302 that controls the operation of the cluster 300.

The hardware 324 of the cluster 300 includes the nodes as previously described where each node typically has a processor, memory, and a network connection. The nodes or hardware 324 can be implemented using commodity blades, servers, towers, laptops, mobile devices, and the like. Because hardware can join/exit the cluster, the computing resources administered by the admin nodes or through the master nodes can grow dynamically.

The software 326 of the cluster 300, in addition to including the control plane, can be organized into various tiers. The user tier 310, for example, typically includes user images or a store of user data and images. The application tier 312 includes application images or a store of application images. The resources tier 314 includes a server software store and an operating system image store. The control tier 316 is used by the control plane to access the other tiers 310, 312, and 314.

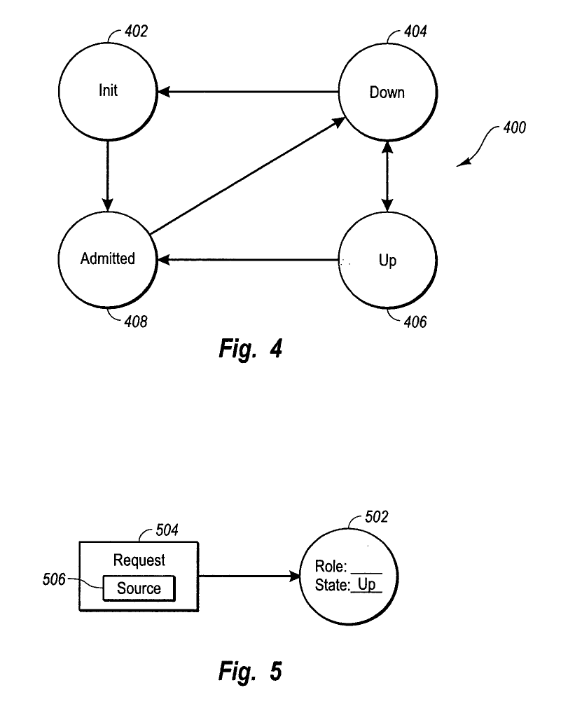

FIG. 4 illustrates an example of the state transitions for nodes in a cluster or for nodes that may join a cluster. FIG. 4 is not an exclusive list of possible states for nodes in the cluster. The INIT state 402 indicates that the node is not necessarily a member of the cluster. When joining a cluster, the node typically performs an authentication procedure with a master node in order to enter the node and achieve the ADMITTED state 408. After the node is admitted, it typically does not have the necessary software to perform any particular role within the cluster. Thus, the node is provisioned with the necessary software or images under the control of the master node. After loading the software images, the admitted node may enter the UP state 406, where it is a fully functional member node of the cluster.

The node can transition from the UP state to either the DOWN state 404 or the ADMITTED state 408. In the DOWN state 404, the node is typically offline. For stateless functioning, the node may not be able to transition from the DOWN state 404 directly to the UP state 406.

When a node is a member of a cluster, there are various events or requests that cluster members handle when in an UP state. An example of a event or a request received by a node is illustrated in FIG. 5. FIG. 5 illustrates a node 502 in an UP state, although the node 502 can have other states. The node 502 has a role (e.g., master, slave, server) and the request received by the node 502 may depend, as explained below, on the specific role of the node 502. The request 504 is typically generated by a source 506. The source of the request 504 can be the node 502 itself.

The following requests are examples of the request 504 that may be received by any node, regardless of the node's role. Typically, the request 504 is generated by a master node or from an admin node. A heartbeat request is a request to confirm that the receiving node is operational and may be sent periodically or as provisioned during admittance of the node to the cluster. A master node or an admin node may also send requests to collect monitoring or statistics from the receiving node. Policy change requests typically originate with admin nodes.

A request may take the node to another state or transfer the responsibilities of the node to another node. A node can also monitor its own resources as well as monitor the status of its master. The node 502 can then generate a request to a master node based on the status of its resources or of the status of its master.

If the role of the node 502 is as a master, it typically experiences events or receives requests from many nodes both within and outside of the cluster. As a master node, the node 502 may receive requests from an admin node relating to policy changes, monitoring information requests, shutting down parts of the cluster, and other management requests. The node 502 can generates its own events or requests to itself to send out heartbeat signals to slave nodes and then receive heartbeat responses in answer. The node 502 can receive a request from a terminal node when a user session is initiated. An external node may request admission to the cluster. An admin node may request the removal of a slave node from the cluster. These and other requests are examples of the requests received by a master node.

If the role of the node 502 is slave only (meaning it is not a master to other slave nodes but is strictly a slave node), it can receive other requests in addition to the requests previously described. Typically, a slave only node receives a request to initiate a user session. The node 502 in this role can also generate a request that the user session has failed. The master node or admin node may send a request to the slave only node that the user session stop, transfer, backup, etc. If the role of the node 502 is a server, then the node 502 typically receives requests for service from both master nodes and slave nodes.

Cluster Operation

The process of admitting a node to a cluster often begins when a request for admission is received at a master node. The master node authenticates the requesting node and asks for more information if needed. If the requesting node is authenticated, then the master node sends a slave ID, server information, and software to the new slave. Next, the role of the node is determined and the necessary policies are sent to the node based on the role of the node. The master updates a slave database and the state of the node becomes ADMITTED. The slave is then brought up by loading the software image, assuming its role, and changing its state to UP.

From the perspective of the node requesting admittance to the cluster, the node sends the admittance request to a master node. If authentication of the requesting node fails, the requesting node is outside of the cluster and is not admitted. If authenticated, the new slave node saves the master node information and requests a unique identifier from the master node. The new slave node then requests server information from the master node. Finally the new slave node requests role information from the master node. Once this information is received, the node is ADMITTED and is then brought online where its state is changed to UP.

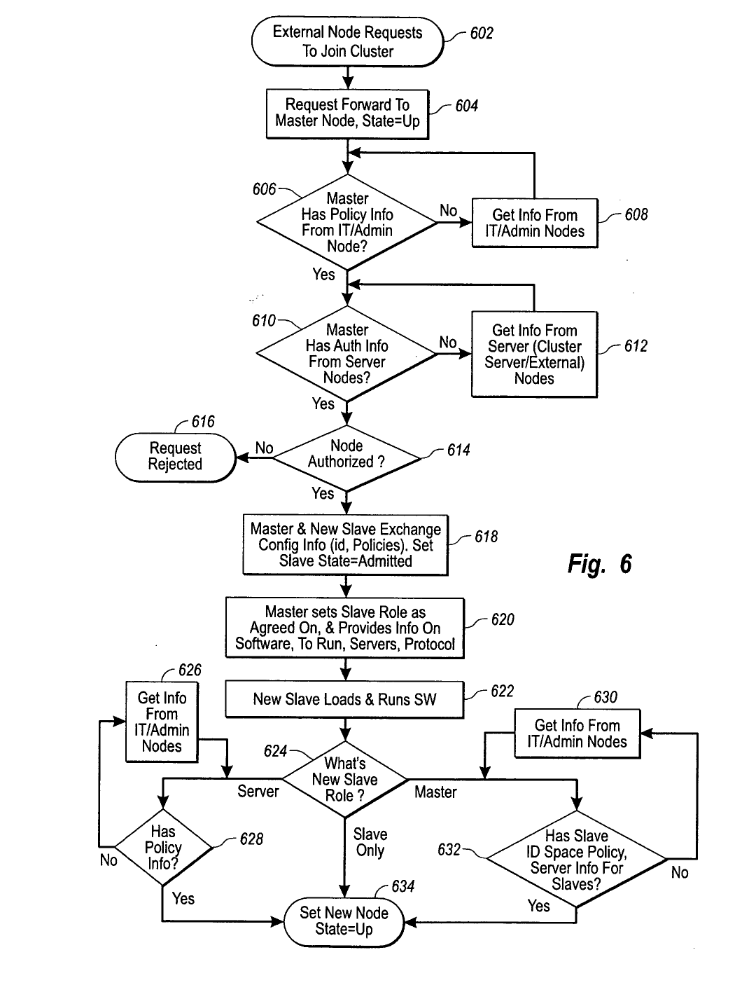

FIG. 6 illustrates an exemplary method for admitting a node to a cluster. The method begins when an external node requests to joint the cluster 602. The node requesting admittance to the cluster can be, for example, commodity hardware, a laptop that is accessing a local network over a network, and the like. The admittance request is typical directed to a master node 604 whose state is UP. The master receiving the admittance request determines if it has the necessary policy information from an admin node 606.

If the policy information is not available to the master node, the master node obtains the policy information from an admin node 608. Otherwise, the master node obtains authorization information from a server node 610. The server may be external to the cluster. Thus, the server obtains the authorization information 612 from the server or proceeds to determine if the node requesting admittance is authorized 614. If the node is not authorized, then the admittance request is rejected 616.

If the node is authorized, then the new node is typically configured as a slave to the admitting master and the master and the new slave node exchange configuration information 618 and the state of the new slave node is ADMITTED. The configuration information can include Identifiers, policies, and other information that may be included in the policies of the master node. The master node then sets the role (or other agreed upon role) to the slave role and provides the new slave node with information on software to execute, servers, and protocols 620. In other words, the software, servers, applications, etc. are identified or provisioned to the slave such that the slave node can service user requests and perform other functions related to the cluster. The new slave node then loads a cluster image and runs the software 622.

Next, actions are taken based on the role 624 of the newly admitted slave node. The new node can be a server node, a slave only node or a master node, or any combination thereof. It is already, in this embodiment, a slave node to the admitting master node. If the role of the node is slave only, then the node state is simply set to UP 634 and the role property is updated accordingly. If the role is a server, the node is provided with the policy information 628 (the necessary policy information may be obtained from a master node or an admin node 626), and the state is set to UP 624 and the role property is set to server node. If the role is as a master, the slave ID space, necessary policies, and server info for slaves is identified 632 and obtained if necessary from a master node or admin node 630, and the state is then set to UP 634 and the role property is set to master node.

When a node is being admitted as a master, the node requests information on all servers in the cluster, receives and loads a master software image, and receives a slave node space to control. The node, once admitted, may take over slave nodes from the admitting master node or from other master nodes. The new master node then takes ownership of the slave nodes and starts its master role with a state of UP.

When the node is being admitted as a slave node, the slave node attempts to identify its own resources and provide this information to the master node. The slave then requests information on the servers of the cluster and the software available including operating systems. After this information is received, the slave node starts its slave role with a state of UP.

When the node is admitted as a server node or server only node, it identifies its own resources and provides this information to the master node. The new server node then requests information of the software to run as well as the appropriate policies. The new server node then loads and runs the software with the relevant policies loaded. The server role is then initiated and its state is UP.

In addition to adding a node to the cluster, an entire sub-cluster rooted at a single master can request admittance to a cluster. This enables the cluster to grow in a controlled hierarchy. During the addition of a sub-cluster, the sub-cluster should be temporarily locked to prevent the addition/deletion of slaves or policy changes once a request to join another cluster has been executed. Further, the slave nodes should not accept user sessions during joining a new cluster.

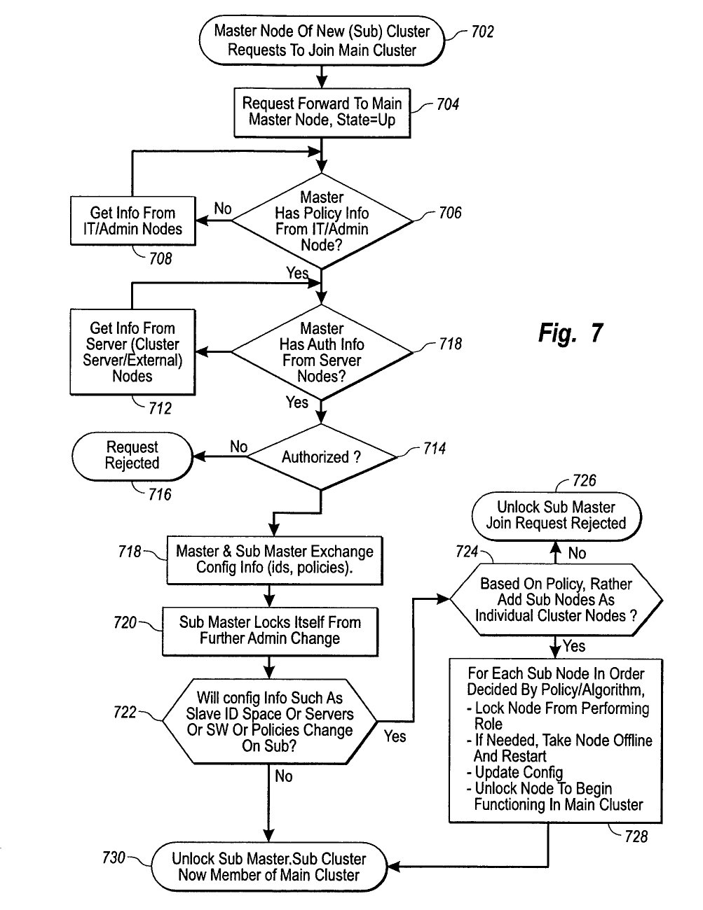

FIG. 7 illustrates an exemplary method for joining a sub-cluster to a cluster. A master node of a sub-cluster requests to join a main cluster 702. The request is typically forwarded to a master node whose state is UP 704. If the receiving master does not have the necessary policy information 706, the policy information is obtained from the admin nodes 708. If the receiving master node does not have the authentication information 710, the authentication information is also requested from a server node (either in the cluster or outside the cluster) 712. If the requesting sub-cluster is not authorized 714, the admittance request is rejected 716.

If the requesting sub-cluster is authorized 714, then the master and the sub-master exchange configuration information 718 including, for example, identifiers and policies. The sub-master locks itself and its slaves from further administrative change 720 for the duration of the admittance process.

If the configuration information of the sub-master, such as by way of example, slave ID space, server information, software, or policies, does not change, the sub-master is unlocked and is a member of the main cluster 730. If the configuration information changes 722, then various actions are taken on according to set policies 724.

For example, the nodes in the sub-cluster can be reconfigured for different roles within the main cluster and the unlock request is rejected 726. Otherwise, each node in the sub-cluster can be locked 728 from performing their respective role and then reconfigured to begin functioning in the main cluster according to newly assigned roles. This may include taking each node offline and restarting each node, updating the configuration of the node, and the like. Finally, the nodes are members of the main cluster 730.

User Sessions

As previously indicated, the cluster is used to administer and allocate the computing resources for users. A user session corresponds to a session where resources are allocated to a user. The resources typically include an operating system instance or image, software, server services, hardware, and the like depending on the session. After a user sends a request to the cluster via a terminal node, the user is authenticated by a master node. The master node then commissions a slave node to service the user session to the terminal node. The master node may take into consideration policies and user information on the slave nodes, to identify the correct slave node to host the user session. In some embodiments, the user session is continuously backed up to a storage device that can be accessed later if a backup session needs to be launched.

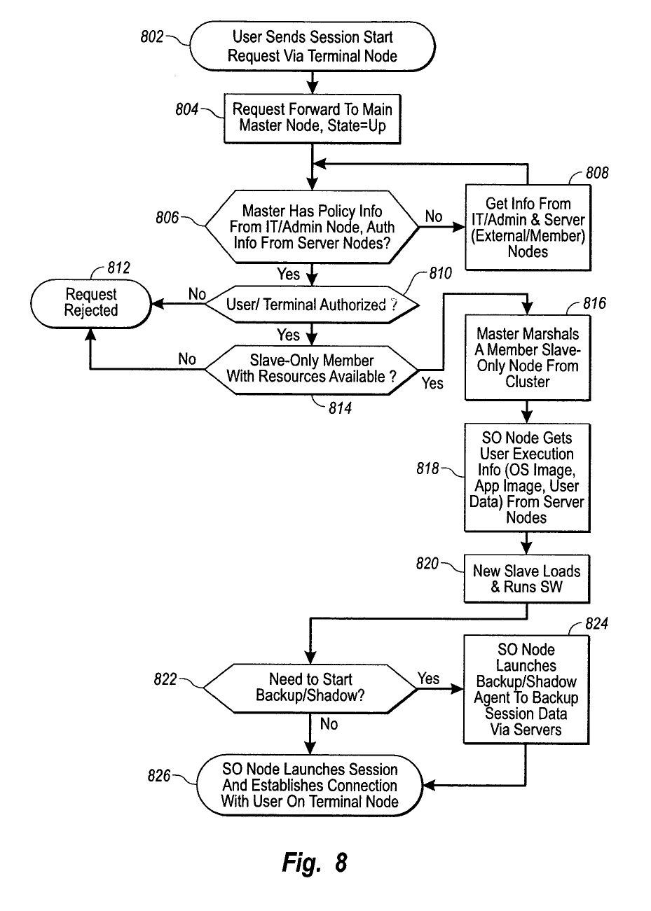

FIG. 8 illustrates an example of establishing a user session in the context of a cluster as described herein. A session typically begins when a user sends a session request from a terminal node 802. The user request is forwarded to a master node 804 whose state is UP. The master node either has the necessary policy information from the admin nodes and/or the authentication information from the server nodes 806 or the master node obtains this information 808. If the user or terminal node is not authorized 810, the user request is rejected 812.

In this example, a slave node or a slave only node should be available 814 to service the user session at the requested level of service quality, or the user request is again rejected 812 per policy. If a slave node or slave only node is available, the master node then marshals a slave node or a slave only node from the cluster 816 to service the user session. The slave or slave only node obtains the user execution information, which includes, an operating system image, an application image, user data, etc., from the server nodes 818. This illustrates the ability to operate a user session that is substantially independent of the operating system as any operating system image can be included or applied to the user session.

Next, the assigned slave node loads and runs the software 820, including the operating system image, application image, and user data. If a backup is required for the user session 822, the slave node launches the agent that backs up the session via the servers 824 to an appropriate storage medium. The slave node then launches the user session and establishes a connection with the user at the terminal node 826.

Depending on policy, nodes being removed from the cluster should be properly shut down. Services being provided by this node can be shut down forcefully or gracefully, or allowed to finish. If a sub-cluster is being removed from the main cluster, the removal may only be a severance of the tie between the sub-cluster and the main cluster. This could enable the removed sub-cluster to continue functioning as a cluster. Alternatively, each node in the sub-cluster may have to be removed individually.

Cluster Embodiment

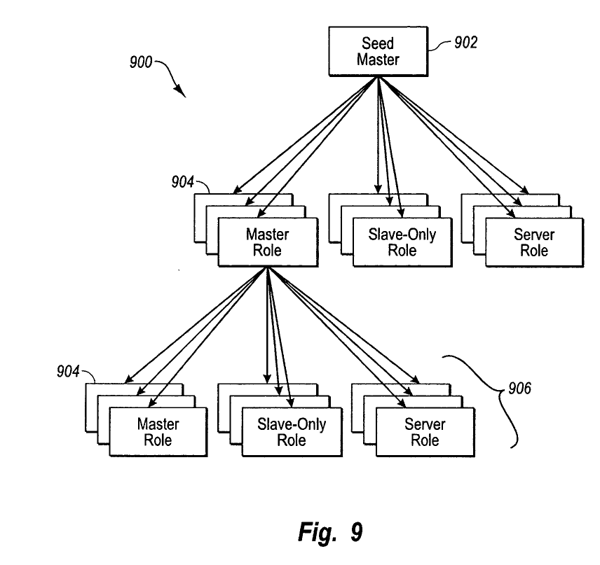

FIG. 9 illustrates an exemplary embodiment of a cluster 900. The cluster 900 begins with a seed master 902, which communicates with external admin and server nodes to bring up other members of the cluster. The members of the clusters that are configured as master nodes 904 are able to admit other members to the cluster 900 and have descendents.

The cluster 900 can develop a depth that can support a large enterprise. For example, a tree of order 10 (number of direct descendants of a master node) and a depth of three (number of levels in the tree) can support over 1000 nodes in the cluster. If 1 in 10 nodes are used for administration, over 900 nodes can be allocated to serving user sessions in the enterprise. Further, fail over policies can be implemented easily. Sibling nodes in the tree, for example, can be provisioned for fail-over of slave only or server nodes. Parent or grandparent, or sibling master nodes in the tree can be provisioned as fail-over or backup master nodes for other master nodes. The master nodes 904 comprise the control plane of the system and some may be configured as admin nodes.

One advantage of the cluster 900 is that is can be adapted to the organization of a corporation or other entity. The sub-cluster 906, for example, may be a sub-cluster that corresponds to a particular department of the corporation. The sub-cluster 906 can also be dedicated to a particular geographic region of an entity. When necessary, the sub-cluster can be admitted to the main cluster 900. This enables the cluster 900 to be constructed by attached sub-clusters rather than adding each node individually.

The management information on all cluster descendants could be hosted at the sub-cluster root master node and forwarded to the administrated directly instead of having to funnel all the information up to the seed node of the cluster. The sub-clusters can continue operation even in tree predecessors fail. Thus, the operation, management and administration of the cluster could be divided between sub-cluster trees, while still maintaining a monolithic tree view of the cluster 900.

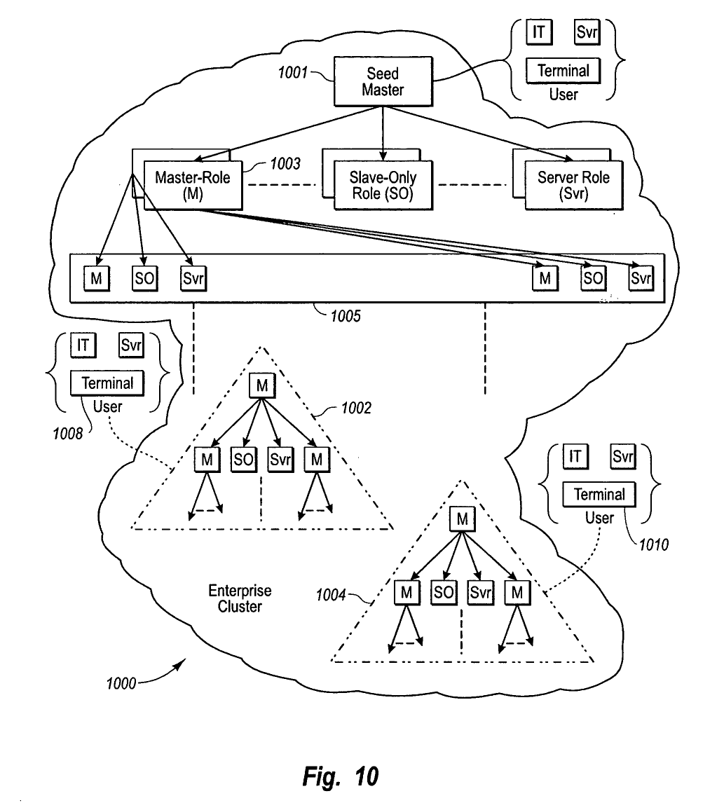

FIG. 10 illustrates an embodiment of an enterprise cluster 1000. The enterprise cluster 100 illustrates sub-clusters 1002 and 1004 that can join/exit the enterprise cluster 1000. The cluster 1000 has a master node 1001, which is a seed master in this example. The master node 1001 is provisioned by admin nodes and communicates with admin nodes and server nodes to bring up other members of the cluster 1000.

The new members of the cluster 1000 that are given a role of master are able to have additional descendants in the cluster 1000. For example, the node 1003 has descendants illustrated by the nodes 1005. Within this cluster 1000, which is organized with a tree hierarchy, sibling nodes can be provisioned as secondary master nodes to implement failover policies. Sibling nodes can be provisioned for failover of slave only or server nodes. Parent, grandparent and sibling master nodes in the tree can be provisioned as failover or backup master nodes for current master nodes. The master nodes in the cluster 1000 can constitute the control plane in one embodiment as the master nodes can administer its descendant nodes and children nodes.

One advantage of the cluster 1000 is its ability to operate within the structure of an organization such as a corporation. The sub-cluster 1002, for example, could be a branch of the tree hosted as a specific master node within the tree. The control plane, as previously stated, can be implemented through the master nodes such that the sub-cluster 1002 can be administered.

The sub-clusters 1002 and 1004 can operate independently of the cluster 1000 or as part of the cluster 1000. The sub-clusters 1002 and 1004, for example, can be dedicated to specific departments within a corporation and managed by local admin nodes. The sub-clusters 1002 and 1004 may also have dedicated server nodes. Access to the sub-clusters 1002 and 1004 can be limited to specific terminal nodes. The terminal nodes 1008 can be used to access the sub-cluster 1002 and the terminal nodes 1010 can be used to access the sub-cluster 1004.

Another advantage of the sub-clusters 1002 and 1004 is that they can continue operation even if predecessor master nodes in the cluster 100 fail. Thus, the operation, management, and administration of the cluster 1000 can be divided between sub-clusters while still maintaining a single monolithic view of the cluster 1000. Further, the sub-clusters 1002 and 1004, can be added or removed from the cluster 1000 as a whole rather than as individual nodes.

Fail-over and Cluster Availability

There are instances when user sessions may fail or one or more of the nodes in the cluster may fail. Clearly, the failure of a node can have an impact on user sessions and other functions of the cluster. Sometimes, it may be necessary to take cluster nodes offline for planned periods of time for maintenance purposes without causing disruption to user sessions. Embodiments of the invention can recover from and adjust for various situations as discussed below.

One advantage over traditional systems is that when user sessions fail, they will not always bring down the underlying physical slave node, as such failures can be quarantined in their virtual containers. The cluster environment also enables us to store away the user session state for later debugging or other analysis. Further, the user session may be backed up and can migrate to another virtual container.

When a master node fails and reboots, the impact on the cluster operation is minimized by detaching the slave nodes from the master. This enables the slave nodes to continue conducting the user sessions until the master can reassert its master role or until a secondary master assumes control of the slave nodes. The slave nodes should have the information needed to run the user sessions independently of the master node.

When a slave node fails, the master should ensure that resources assigned to that node are cleaned up after saving information that can be used for later analysis or recovery. In addition, slave nodes can notify their master that they are running out of resources. The master can then take appropriate action per defined policy. The master may, for example, identify and shut down rogue or lower-priority user sessions on the slave node, and/or take this information into account while balancing cluster load for future user requests.

From the perspective of the end user, the disruption of the user session is minimal. In one example, the user session is migrated to an alternate slave node if the slave node servicing the user session fails or begins to run out of resources. While the user session is migrating, user actions such as key strokes, mouse movements, etc, can be captured and applied to the new session. The new user session should be protected when the captured actions are applied.

In one embodiment of the cluster, the master nodes can have a redundant system to protect the cluster when a master node fails. A secondary master, for example, can assume the responsibilities of a primary master upon failure of the primary master. The secondary master could be a slave to the primary master in some instances. When the secondary master assumes the role of master, an inventory of the slave nodes is taken to ensure that the new master has an understanding of the user sessions occurring on the slave nodes within the cluster or sub-cluster.

When a software update to the cluster is scheduled, an updating policy is followed. For example, the master node should assign itself an UPDATING state and update the new software image in an alternate region before committing to the new software image. The secondary masters are alerted of the update and the new software image is provided to the secondary masters. The secondary masters then load the new software image in an alternate region while still running the old image.

Each slave node is then alerted that an update is occurring and be placed in and UPDATING state. Information on the slave nodes is backed up preferably. To avoid disruption to the end user, the actions (keystrokes, etc.) of the user should be stored in a temporary file. Sessions that cannot be interrupted may be executed on a single slave node while the other nodes update. Slaves are then updated, either together or one by one, and the saved user actions are applied as needed. Once the slaves are updated, the secondary masters are then updated followed by the master node.

A similar algorithm as described above is applied when updating policy and configuration changes on a cluster.

Operating Environments and Terminology

The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussions are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A cluster for managing resources in a computer network, the cluster comprising:
a plurality of slave nodes;
a plurality of master nodes, each master node being a master for a set of specified slave nodes from the plurality of slave nodes, wherein requests for admittance to the cluster are handled by the plurality of master nodes; and
a control plane including one or more admin nodes, wherein the one or more admin nodes provision and administer the plurality of master nodes using the control plane.

2. A cluster as defined in claim 1, wherein at least one of the plurality of slave nodes is also a master node and wherein at least one of the plurality of slave nodes is a slave only node.

3. A cluster as defined in claim 1, wherein the plurality of master nodes assign a role to each node admitted to the cluster, wherein the role is at least one of a server role, a master role, a slave role, and a slave only role.

4. A cluster as defined in claim 1, wherein the plurality of master nodes receives and processes requests for admittance to the cluster from a sub-cluster.

5. A cluster as defined in claim 1, wherein the plurality of master nodes receive user session requests and direct one or more slave nodes to initiate and conduct the user session with a user at a terminal node.

6. A cluster as defined in claim 1, wherein a particular master node provisions the slave node conducting the user session with at least the required firmware, an operating system image, an application image, and user data to initiate and conduct the user session in a virtual container, wherein the virtual container includes one or more policies determined by an administrator.

7. A cluster as defined in claim 7, wherein a particular admin node is included within the cluster and has a role in the cluster such that resources of the particular admin node can be allocated to a user session.

8. A cluster as defined in claim 1, wherein a plurality of terminal nodes provide an interface to conduct user sessions with the cluster.

9. A cluster as defined in claim 8, wherein a particular terminal node is included within the cluster and has a role in the cluster such that resources of the particular terminal node can be allocated to a user session.

10. A cluster as defined in claim 1, wherein each of the plurality of slave nodes and the plurality of master nodes have at least one property, the at least one property including one or more of:
a role property;
a state property, wherein the state comprises one of DOWN, ADMITTED, INIT, and UP;
an identifier;
an identifier of a primary master node;
an identifier of a secondary master node or nodes;
a policy on heartbeats with a master node;
a policy on failure of a master node;
a resource usage information view that includes a profile on usage of a processor, memory, network I/O, and disk I/O, and a policy on acceptable levels for intended operation;
a firmware property that identifies and manages the node hardware before selection of the appropriate operating system
a software property that includes information on software to execute, protocol to run, and server locations in the cluster; and
a policy on communication to determine how the node communicates with other nodes in the cluster and nodes or networks outside the cluster.

11. A cluster as defined in claim 10, wherein each of the at least one property for each node with a master role further comprises one or more of:
a list of slave nodes;
configuration information for each slave node in the list of slave nodes;
monitoring information including resource usage and active user session information;
at least one policy on interaction with an admin node; and
at least one policy on user session scheduling for each slave node in the list of slave nodes.

12. A cluster as defined in claim 10, wherein each of the at least one property for each node with a slave only role further comprises monitoring information including user session information and master node state information.

13. A cluster as defined in claim 10, wherein each of the at least one property for each node with a server role further comprises one or more of:
an authentication policy including rules to accept or reject a client request; and
monitoring information including a transaction history for other nodes and master node state information for at least one master node.

14. A cluster as defined in claim 1, further comprising a plurality of server nodes that provide services to cluster, wherein each of the plurality of slave nodes, each of the plurality master nodes, and each server node handles events related to the operation of the cluster.

15. A cluster as defined in claim 10, wherein each master node distributes a request for a user session to a slave node.

16. A cluster as defined in claim 10, wherein the control plane interacts with the plurality of master nodes to prevent failure of the cluster when one or more of the plurality of master nodes fail by migrating operations and functions of the failed master nodes to one of other master nodes in the cluster or to other slave nodes that are assigned master roles.

17. A method for admitting a node to a cluster, the method comprising:
receiving a request from a node to join a cluster, wherein the request is received at a master node;
determining if the node is authorized to join the cluster;
if the node is authorized, exchanging configuration information between the node and the master node such that the node is admitted to the cluster;
provisioning the node with firmware, a software image and server information that are loaded by the node; and
setting one or more roles for the node, wherein the node is up in the cluster and performing in the set roles.

18. A method as defined in claim 17, wherein determining if the node is authorized to join the cluster further comprises determining requesting policy information for the node from an admin node.

19. A method as defined in claim 17, wherein determining if the node is authorized to join the cluster further comprises requesting authorization information from a server node.

20. A method as defined in claim 19, wherein the server node is one of inside the cluster or external to the cluster.

21. A method as defined in claim 17, wherein exchanging configuration information between the node and the master node further comprises exchanging identifiers and policies between the node and the master node.

22. A method as defined in claim 17, wherein provisioning the node with a software image and server information further comprises provisioning the node with a boot-up protocol.

23. A method as defined in claim 17, wherein setting a role for the node further comprises at least one of:
setting the role of the node to a server role;
setting the role of the node to a master role;
setting the role of the node to a slave role; and
setting the role of the node to a slave only role.

24. A method as defined in claim 23, wherein setting the role of the node to a master node further comprises determining a slave identifier space for the node.

25. A method as defined in claim 24, further comprising providing the node with server and configuration information for slave nodes of the node.

26. A method as defined in claim 23, further comprises reporting resources including hardware and firmware of the node and reporting information regarding the resources of the node to the master node.

27. A computer program product having computer executable instructions for performing the method of claim 17.

28. A method for admitting one or more sub-clusters to a main cluster, the method comprising:
receiving a request from a sub-cluster to join a main cluster;
determining if the sub-cluster is authorized to join the main cluster, wherein the request is denied if not authorized;
if the sub-cluster is authorized, exchanging configuration information between the master in the main cluster and the master in the sub-cluster;
locking the sub-cluster from performing further changes or accepting future user requests;
if configuration information of the sub-master does not change, adding the sub-cluster to the main cluster; and
unlocking the sub-cluster such that the sub-cluster can function as part of the main cluster.

29. A method as defined in claim 28, wherein if configuration information of the sub-cluster does change, adding the sub-cluster to the main cluster further comprises:
adding the sub-cluster as individual nodes; and
for each node in the sub-cluster:
locking node from performing its current role;
updating the configuration of the node including the role; and
unlocking the node to begin functioning in the main cluster.

30. A method as defined in claim 29, further comprising taking each node offline and restarting each node from its firmware.

31. A method as defined in claim 28, wherein determining if the sub-cluster is authorized to join the main cluster further comprises obtaining policy information from an admin node and obtaining authorization information from a server node.

32. A method as defined in claim 28, wherein exchanging configuration information further comprise exchanging at least identifiers and policies.

33. A method for performing a user session in a cluster, the method comprising:
receiving a user session request from a user at a terminal node;
determining, by a master node that receives the user session request, whether at least one of the user and the terminal node is authorized for a user session with the cluster;
selecting a slave node to conduct the user session;
providing the slave node with execution information for the user session;
loading the execution information at the slave node, while leveraging a pre-loaded base execution environment at the slave node if one such environment exists; and
launching the user session between the slave node and the terminal node.

34. A method as defined in claim 33, wherein selecting a slave node to conduct the user session further comprises:
determining if a slave only node with resources is available for the user session; and
determining if the slave only node can satisfy a level of quality of service determined by a combination of pre-defined policy and run-time request.

35. A method as defined in claim 33, wherein determining, by a master node that receives the user session request, whether at least one of the user and the terminal node is authorized for a user session with the cluster further comprises analyzing policy information from an admin node and obtaining authorization information from a server node.

36. A method as defined in claim 33, wherein providing the slave node with execution information for the user session further comprises providing the slave node with an operating system image.

37. A method as defined in claim 33, wherein providing the slave node with execution information for the user session further comprises providing the slave node with one or more application images.

38. A method as defined in claim 33, wherein providing the slave node with execution information for the user session further comprises providing the slave node with user data.

39. A method as defined in claim 33, further comprising backing up the user session via a server node to a storage medium.

40. A method as defined in claim 33, further comprising:
suspending the user session; and
resuming the user session at a later time on one or more different physical nodes included in the cluster or connected to the cluster.

41. A method as defined in claim 33, further comprising migrating the user session to a new slave node if the slave node fails.

42. A method as defined in claim 41, further comprising storing user actions to avoid disruption of a user session during migration of the user session to the new slave node.

43. A method as defined in claim 41, further comprising applying the previously stored user actions to the user session after it resumes on the new slave node or nodes.

44. A method as defined in claim 33, further comprising monitoring resources of the slave node during the user session.

45. A computer program product having computer executable instructions for performing the method of claim 33.

46. A method for updating a software image of nodes in a cluster, the method comprising:
loading a master node with a copy of a new software image in preparation to update nodes in the cluster;
loading each secondary master with the copy of the new software image;
alerting each slave node of the master node that an update including the new software image is occurring;
updating each slave node with the new software image;
after each slave node is updated, updating each secondary master using the loaded copy of the new software image on each secondary master; and
after each secondary master is updated, updating the master node with the copy of the new software image.

47. A method as defined in claim 46, further comprising backing up each slave node image before each slave node is updated with the new software image.

48. A method as defined in claim 47, further comprising rolling back the executing software to a pre-update version of the software image on the master node, each secondary master, and the slave nodes in the event of a failure during update process.

49. A method for updating a policy or a configuration of nodes in a cluster, the method comprising:
alerting a master node in the cluster with an update for one or more slave nodes, wherein the update includes at least one of a configuration change information and a policy change information;
alerting each slave node of the master node that the update is occurring;
updating the one or more slave nodes with the update;
updating each secondary master with at least one of a configuration change information and a policy change information included in the update; and
updating the master node with the update; and
unlocking the cluster if the cluster is locked.

50. A method as defined in claim 49, further comprising the authentication of the change request by master or a server node before applying it to the cluster.

51. A method as defined in claim 49, wherein alerting a master node in the cluster with an update further comprises locking the cluster from external requests.

52. A computer program product having computer executable instructions for performing the method of claim 49.
